(19) United States
(12) Patent Application Publication
(10) Pub. No.: US 2024/0418891 A1
(43) Pub. Date: Dec. 19, 2024

(54) Method and device for locating an optical fiber

(71) Applicant: ORANGE, ISSY-LES-MOULINEAUX (FR)

(72) Inventors: Christian Gregoire, CHATILLON CEDEX (FR); Nicolas Pellen, CHATILLON CEDEX (FR)

(21) Appl. No.: 18/745,252

(22) Filed: Jun. 17, 2024

(30) Foreign Application Priority Data
Jun. 19, 2023 (FR) 2306295

(51) Int. Cl. G01V 1/34; G01V 1/143; G01V 9/00; G06T 19/00

(52) U.S. Cl. CPC G01V 1/345; G01V 1/143; G01V 9/005; G06T 19/006

(57) ABSTRACT

A method and a device for locating an optical fiber buried in a volume. More particularly, the method includes at least: determining a position of the optical fiber, based on at least one detection level of a source of radiation for at least one position of the source, provided by a detection device connected to the optical fiber.

### CROSS REFERENCE TO RELATED APPLICATION

This application claims priority to and the benefit of French Patent Application No. 2306295, filed Jun. 19, 2023, the content of which is incorporated herein by reference in its entirety.

### FIELD OF THE DISCLOSURE

The present disclosure relates to the field of locating networks of optical fibers. More particularly, the present disclosure relates to a method and a device for locating an optical fiber, as well as an associated system and computer program.

### BACKGROUND OF THE DISCLOSURE

The disclosure lies in the context of the location of buried optical fibers, such as optical fibers buried e.g. in the ground of a building or of a street. In fact, there are significant differences between the location information entered at the installation of an optical fiber and the actual position of the fiber. The differences often reach several tens of centimeters. However, it is essential to be able to locate with precision a buried optical fiber, in particular to prevent damaging the fiber during work, or to add an optical connection point, or else to repair the fiber.

Unlike an electrical cable, an optical fiber buried in a ground cannot be detected by analyzing the electromagnetic field on the ground surface.

For this reason, a known solution for locating a buried optical fiber consists in inserting a metal needle into the sheath containing the optical fiber, then detecting the needle by electromagnetic means. The needle is supplied with an electrical voltage at a given frequency, which allows the needle to be located on the surface using an electromagnetic detector. However, such solution has a certain number of drawbacks, and in particular the following.

On the one hand, the sheath of the optical fiber may be obstructed or occupied by other cables, or even have bends. In which case, it is simply not possible to insert a metal needle into the sheath of the optical fiber to locate the latter. On the other hand, the location accuracy of the existing solutions is not entirely satisfactory. Electromagnetic noise from various sources, such as interference with nearby electrical networks or thermal noise, disturbs the location measurements of the metal needle and degrades the location accuracy of the optical fiber.

Therefore, there is a need for a solution enabling a buried optical fiber to be located with precision in a non-invasive way (i.e. without having to dig into the ground).

### SUMMARY

An exemplary embodiment of the present disclosure is directed to overcoming all or part of the drawbacks of the prior art, in particular those described previously.

To this end, and according to one aspect of the disclosure, a method is proposed for locating an optical fiber buried in a volume, the method comprising at least:
determining a position of the optical fiber, based on at least one detection level of a source of radiation for at least one position of the source, provided by a detection device connected to the optical fiber.

The proposed solution allows locating with precision an optical fiber buried in a volume (e.g. a floor or a wall), in a non-invasive way.

More particularly, the proposed solution uses the property according to which an optical fiber allows to detect a mechanical or acoustic wave propagating through the ground. The source of radiation (e.g., a loudspeaker, or a percussion device, or a torch) is located at or near the surface of the ground. Same generates e.g. acoustic or mechanical vibrations. Such vibrations propagate in the form of waves in the ground and induce deformations (elongations or compressions) of the optical fiber.

The detection device is connected to an end of the optical fiber to be located and uses the optical fiber as a sensor to detect the vibration source. The above is a device for distributed acoustic detection or a device for distributed vibration detection. Such device sends light pulses into the optical fiber and measures the characteristics of the reflected light and measures the deformation of the optical fiber induced by vibration. In fact, acoustic or vibratory disturbances induce deformations of the optical fiber, which modifies the characteristics of the reflected light (e.g. the amplitude, the phase of the light).

The detection device thereby provides a detection level of the vibration source. The detection level depends on the distance between the source and the optical fiber. The closer the vibration source is to the fiber, the greater the deformation of the fiber induced by the vibrations, and the higher the detection level of the source.

By using the detection level(s) obtained for different positions of the vibration source, the proposed solution is used to estimate a position of a point of the optical fiber with respect to the ground surface. The proposed solution thereby allows locating the path of the fiber through the ground.

Hereinabove, we have described the operation of the proposed solution with reference to a source of vibration. It should be noted that the proposed solution works similarly in the case of a source of heat. The source of heat causes thermal conduction in the ground, which further induces a deformation of the optical fiber and can be detected by the detection device.

According to other particular embodiments, the locating method may include one or more of the following features, taken individually or according to all technically possible.

According to one embodiment, a detection level of the source is obtained for each of a plurality of positions of the source, and the position of the optical fiber is estimated based on the detection levels obtained.

Such embodiment contributes to locate the optical fiber with precision. The position of the optical fiber is estimated herein by using a plurality of detection levels of the source obtained for different positions, respectively, of the source. The source can thereby be moved step by step in order to obtain different detection levels, and a position of the optical fiber can be deduced therefrom.

According to one embodiment, said estimated position of the optical fiber corresponds to the position of the source for which the detection level obtained is maximum among a plurality of positions of the source situated in a search zone.

According to such embodiment, determining a position of the optical fiber is performed in a given search zone, and a plurality of detection levels are obtained for different positions, respectively, of the source within the search zone. The source is, for instance, moved by a user to reach a maximum detection level, which gives the estimated position of the fiber. Such embodiment thereby allows locating the optical fiber with precision and presents a minimal complexity of implementation.

According to one embodiment, the method comprises a plurality of determining a position of the optical fiber performed for different search zones, respectively, a said position of the optical fiber being determined based on at least one detection level obtained for at least one position of the source included in a said search zone.

The embodiment allows determining the path of the optical fiber. Indeed, a plurality of positions of the optical fiber are determined for different search zones according to the embodiment. A plurality of location points for the fiber are thereby obtained, allowing to characterize the path of the fiber in the ground.

According to one embodiment, the method comprises:
providing a map (e.g., a graphic representation) representative of at least one determined position of the optical fiber.

Such embodiment is particularly advantageous in that it allows to give the location of the optical fiber to a user.

According to one embodiment, the map provided is also representative of at least one theoretical (i.e. expected) position of the optical fiber.

The embodiment allows a user to see the intended location of the optical fiber during the installation thereof and the actual location of the optical fiber, and thereby to find the differences between the two. Indeed, the map provided represents not only the determined positions of the fiber but also the theoretical positions of the fiber, i.e. the location information entered during the installation of the optical fiber.

According to one embodiment, the provision of the map comprises at least one step among the following:
interpolating determined positions of the optical fiber; and
regressing certain positions of the optical fiber.

In the embodiment, it is proposed to interpolate or regress a plurality of determined positions of the optical fiber, which advantageously allows to generate an optical fiber layout. The embodiment allows to give a user the layout of the optical fiber and allows the user to see the path of the fiber.

According to said embodiment, the interpolation or the regression of the determined positions of the optical fiber is performed based on a minimum radius of curvature of the optical fiber.

The embodiment is advantageous in that it allows to obtain a reliable layout of the fiber from a few determined positions of the fiber. Correspondingly, the embodiment allows to reduce the number of positions necessary for the optical fiber to obtain a reliable layout. To ensure the correct operation of the optical fiber, the fiber is installed with a minimum radius of curvature (depending on the type of optical fiber). The embodiment proposes to use the minimum radius of curvature to generate the layout of the optical fiber.

According to one embodiment, determining a position of the optical fiber comprises: obtaining a depth of the optical fiber with respect to a surface of the volume, the depth being determined based on said detection level.

The embodiment allows to locate the optical fiber in three dimensions. Herein, the fiber is located not only in the ground plane, but also in depth. The detection level of the source allows to estimate the depth of the optical fiber, e.g. by using reference models (e.g. a propagation model of acoustic waves in the ground) or reference data (e.g. detection levels obtained for different depths of a fiber in a soil).

According to one embodiment, a said detection level of the source is determined by using at least one neural network.

The use of one or a plurality of neural networks allows to determine a detection level of the source from optical measurements taken at the output of the fiber by the detection device. The neural network(s) are trained to optimize the reliability of the detection of a source of radiation. The embodiment thereby allows obtaining reliable detection levels of the source, and thus contributes to the precise location of the optical fiber.

According to one embodiment, the at least one determining a position of the optical fiber is implemented by a locator device and comprises:
sending an instruction to the source to generate vibrations and/or heat; and/or
sending an instruction to the detection device to measure a detection level.

The embodiment allows automating the location of the optical fiber, and limiting the interventions needed on the part of a user (e.g. a technician). The optical fiber is located herein by a locating device (e.g. a user terminal, or an augmented reality device). The latter controls the source and the detection device. Since the different devices are controlled automatically, the embodiment allows the optical fiber to be located in a particularly precise way.

According to one embodiment, said at least one position of the optical fiber is determined by a user terminal, and said position of the source is obtained by locating the user terminal.

The embodiment is particularly advantageous in that it allows a user to locate a buried optical fiber using only his/her terminal and the detection device. Indeed, the location of the optical fiber is performed by the user terminal (e.g. a mobile telephone or a tablet). It is also considered that the source of radiation is located at (or in the vicinity of) the user terminal. For example, it is the terminal that generates acoustic vibrations with the loudspeaker thereof, or the user (e.g. a technician) equipped with the terminal that generates mechanical vibrations by hitting the ground with a tool.

According to one embodiment, said at least one determining a position of the optical fiber is implemented by a so-called augmented reality device. Furthermore, the augmented reality device determines a given position of the source and indicates the position to a user.

The embodiment makes it easier for a user to locate an optical fiber. The location of the optical fiber is performed herein by an augmented reality device (e.g. augmented reality glasses). The device interactively guides a user to locate the fiber by indicating where the source is to be positioned.

According to one aspect of the disclosure, a device for locating an optical fiber buried in a volume is proposed, the device comprising an optical fiber locator configured to determine at least one position of the optical fiber based on at least one detection level of a source of radiation for at least one position of the source provided by a detection device connected to the optical fiber.

The proposed locating device can be configured to implement any of the embodiments of a method according to the disclosure. More particularly, for each step or operation of a method according to the disclosure, the locating device may comprise a device or a module configured to implement such step or operation.

According to one embodiment, the locating device is (comprised in, implemented by) one of: a user terminal, and a so-called augmented reality device.

According to one embodiment, the augmented reality device includes an indicator configured to indicate to a user a position of the source.

According to one embodiment, the source of radiation is a source of vibration and/or of heat.

According to one aspect of the disclosure, a system for locating an optical fiber buried in a volume is proposed, the system comprising:
a detection device to be connected to the optical fiber and configured to provide at least one detection level of a source of radiation; and
an optical fiber locator configured to determine at least one position of the optical fiber based on at least one detection level.

According to one embodiment, the system comprises the source of radiation, the source being controlled by the locating device.

According to one aspect of the disclosure, a proposed a computer program (or a set of computer programs) is proposed, comprising instructions for implementing the steps of a method according to the disclosure, when the computer program is executed by at least one processor or one computer.

The computer program may consist of one or a plurality of subparts stored in the same memory or in separate memories. The computer program can use any programming language, and may be in the form of source code, object code, or of intermediate code between source code and object code, such as in a partially compiled form, or any other desirable form.

According to one aspect of the disclosure, a computer-readable data storage medium is proposed, comprising a computer program according to the disclosure.

The data storage medium can be any entity or device apt to store the program. For example, the medium may include a means of storage such as a non-volatile memory or ROM, e.g. a CD-ROM or a microelectronic circuit ROM, or else a magnetic means of recording, e.g. a floppy disk or a hard disk. On the other hand, the storage medium may be a transmissible medium such as an electrical or optical signal, which may be routed via an electrical or optical cable, by radio or by a telecommunication network or by a computer network or by other means. More particularly, the program according to an aspect of the disclosure can be downloaded on a computer network. Alternatively, the data storage medium may be an integrated circuit wherein the program is incorporated, the circuit being suitable for executing or being used in the execution of the method in question.

The proposed device, system, computer program and data storage medium have the advantages described hereinabove in connection with the proposed locating method.

### BRIEF DESCRIPTION OF DRAWINGS

Other features and advantages of the present disclosure will emerge from the description provided hereinafter, illustrating embodiments of the disclosure given as an example, but not limited to, with reference to the attached drawings:

FIG. 1 illustrates a system for locating an optical fiber according to an embodiment of the disclosure;

FIG. 2 illustrates the steps of a method for locating an optical fiber according to an embodiment of the disclosure;

FIG. 3 illustrates an example of a search zone for an optical fiber and of detection levels used by a locating system according to one embodiment of the disclosure;

FIG. 4 illustrates an example of search zones for an optical fiber, used by a locating system according to one embodiment of the disclosure;

FIG. 5 illustrates an example of a map provided by a device for locating an optical fiber according to an embodiment of the disclosure;

FIG. 6 illustrates the architecture of a system for locating an optical fiber according to an embodiment of the disclosure; and

FIG. 7, FIG. 8, and FIG. 9 illustrate a system for locating an optical fiber according to embodiments of the disclosure.

### DETAILED DESCRIPTION OF ILLUSTRATIVE EMBODIMENTS

The present disclosure applies, more particularly, to the implementation of systems for locating buried optical fibers. The description of the disclosure hereinafter refers to an optical fiber buried in a ground. However, the disclosure also applies to locating a fiber buried in a wall, a ceiling, or any other volume.

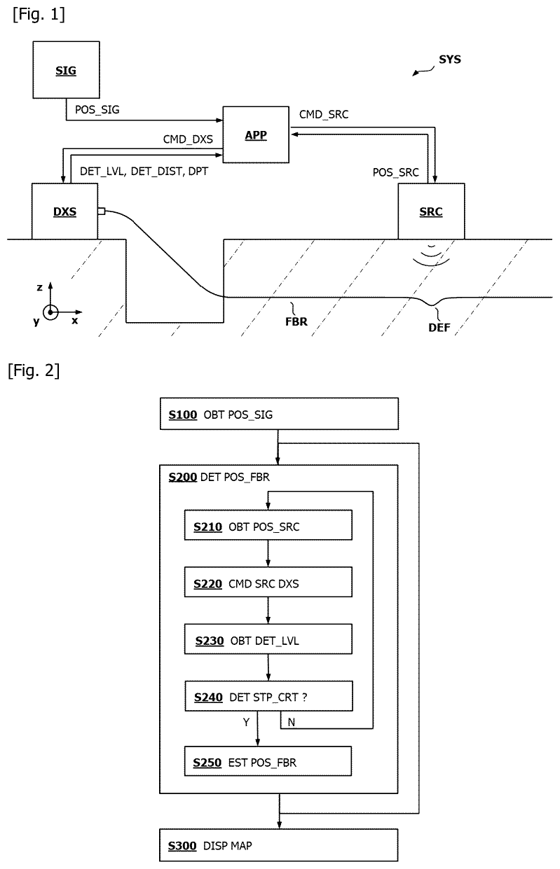

FIG. 1 illustrates a system for locating an optical fiber according to an embodiment of the disclosure. The figure is described hereinafter in order to introduce the present disclosure and to give an example embodiment.

The locating system SYS comprises, according to said embodiment: a locating device APP, a source of radiation SRC, a detection device DXS, and a geographic information system SIG.

The proposed system SYS allows to locate the underground optical fiber FBR. As illustrated in FIG. 1, the optical fiber FBR is partly buried in a ground. The above may be e.g. the floor of a building or a street.

The geographic information system SIG is configured to provide the locating device APP with one or a plurality of theoretical positions POS_SIG of the optical fiber FBR. The theoretical positions correspond to the location information entered during the installation of the optical fiber FBR. As mentioned hereinabove, there may be significant differences between the location information entered at the installation of a fiber and the actual position of the fiber.

The location information can be used by the locating device APP to determine the wherein one should look for the optical fiber FBR, which is described in detail with reference to FIG. 4. The theoretical positions POS_SIG of the fiber FBR can also be indicated to a user by the device APP.

The source of radiation SRC is located at or in the vicinity of the surface of the ground. The source is intended to be detected by the detection device DXS which uses the optical fiber FBR as sensor.

The source of radiation SRC is, according to one embodiment, a source of vibration and/or of heat. The vibration can be mechanical and/or acoustic, etc. The term “acoustic source” means a source configured to emit a sound among all types of sounds: from infrasound to ultrasound going through the audible sounds.

More particularly, the source SRC is configured to generate acoustic and/or mechanical vibrations, and/or heat. Hereinafter, we also use the term “stimuli source” to refer to the source SRC and send to any type of stimuli, in particular acoustic and mechanical vibrations, and heat.

The source SRC may be e.g. a loudspeaker generating acoustic vibrations, or a percussion device generating mechanical vibrations. Acoustic or mechanical vibrations propagate in the form of waves in the ground and cause deformations DEF of the optical fiber FBR (deformations accentuated in the figure, as an illustration). The same applies when the source SRC is a source of heat such as a torch. The source SRC of heat causes thermal conduction in the ground, which induces a deformation DEF of the optical fiber FBR.

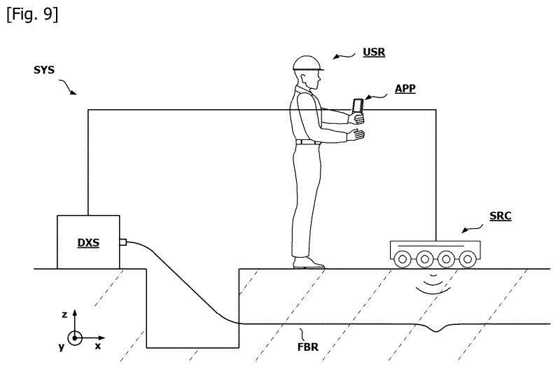

The source SRC can in particular be controlled by the commands CMD_SRC sent by the locating device APP. Same can also be configured to provide the position POS_SRC to the device APP. Other embodiments are presented with reference to FIGS. 7 and 8, wherein the source SRC is not controlled by the device APP but rather by a user (e.g. a technician). The above may involve e.g. involve hammer blows struck by a user on the ground surface. Thereby, the stimuli can be generated manually (e.g. by a technician), or by an automatic source of stimuli.

Further embodiments can be contemplated, wherein the source SRC is apt to produce stimuli of different natures: acoustic vibrations, mechanical vibrations, and/or heat. The type of stimuli generated by the source SRC could thereby be selected based on the nature of the ground. As a result, the detection of the source SRC by the detection device DXS is improved, and thus contributes to locate with precision the optical fiber FBR.

Furthermore, according to one embodiment, the source SRC generates stimuli using a code sequence (e.g. a reference sequence). For example, the source SRC may use a code sequence comprising a series of long and short stimuli. Such a code sequence is known in particular to the detection device DXS, which allows to improve the detection of the source SRC. Indeed, in a noisy environment (e.g. a road with vibrations generated by vehicles or nearby works), the use of a code sequence makes it easier to distinguish stimuli generated by the source SRC from noise or other disturbances. Thereby, the above allows to improve the detection of the source SRC and contributes to accurately locate the optical fiber FBR.

The detection device DXS is connected to one end of the optical fiber FBR (e.g. at an optical connection point). The device uses the optical fiber FBR as a continuous sensor to detect the source SRC.

The detection device DXS may be a distributed acoustic detection device or a distributed vibration detection device. The device could also be a distributed temperature detection device. More particularly, such devices use optical time reflectometry techniques.

The device DXS sends light pulses into the optical fiber FBR and performs optical measurements at the output of the fiber. In this way, by measuring the characteristics of the reflected light (e.g. amplitude, phase, or other optical parameters), the device DXS can detect the deformations DEF of the optical fiber FBR induced by the source SRC.

The detection device DXS is thereby configured to provide a detection level DET_LVL of the source SRC for a given position POS_SRC of the source. The detection level DEL_LVL characterizes a deformation level DEF of the fiber FBR, and thus characterizes the distance between the source SRC and the optical fiber FBR. The closer the source SRC is to the fiber FBR, the greater the induced deformations DEF, and the higher the detection level DET_LVL.

According to one embodiment, the device DXS uses at least one neural network taking optical measurements at the output of the fiber and supplying at the output a detection level of the source DET_LVL. Such a neural network can be trained using simulated (i.e. computer generated) data, and/or field data.

More particularly, the device DXS can use a plurality of neural networks correspondingly dedicated to the detection of a particular type of stimuli. The device can thereby select the neural network used based on the type of stimuli generated by the source SRC.

As illustrated in FIG. 1, the detection device DXS can provide a distance DET_DIST at which the source SRC is detected, i.e. the length of fiber between the deformation DEF and the detection device DXS. The device can also provide a depth DPT of the optical fiber FBR at the deformation DEF (i.e. at the location where the source SRC is detected). The depth of the fiber is defined with respect to the ground surface.

According to the embodiment shown in FIG. 1, the detection device DXS is controlled by the device APP. For example, the device APP sends a command CMD_DXS comprising an instruction for measuring a detection level DET_LVL. In a variant, the device DXS could operate autonomously and regularly provide detection levels DET_LVL to the device APP.

The locating device APP is configured to determine at least one position of the optical fiber FBR. More particularly, same estimates the position of the optical fiber FBR using the detection levels DET_LVL supplied by the device DXS.

The device APP can in particular implement an application intended for a user (e.g. a technician) to enable him/her to locate the optical fiber FBR. For example, the locating device APP may be a user terminal (e.g. a mobile telephone, or a smartphone), or an augmented reality device (e.g. augmented reality glasses).

Augmented reality device refers herein to a device configured to integrate virtual elements (generated by a computer) into a real environment on a display device. It should be noted that a user terminal (e.g. a smartphone) can also implement augmented reality techniques.

The device APP may comprise a display device DISP to indicate to a user: the detection levels DET_LVL provided by the detection device DXS, the theoretical positions of the fiber POS_SIG, and/or the positions of the fiber FBR determined by the device APP. The device APP can also implement the source SRC of stimuli, which is presented with reference to FIG. 8.

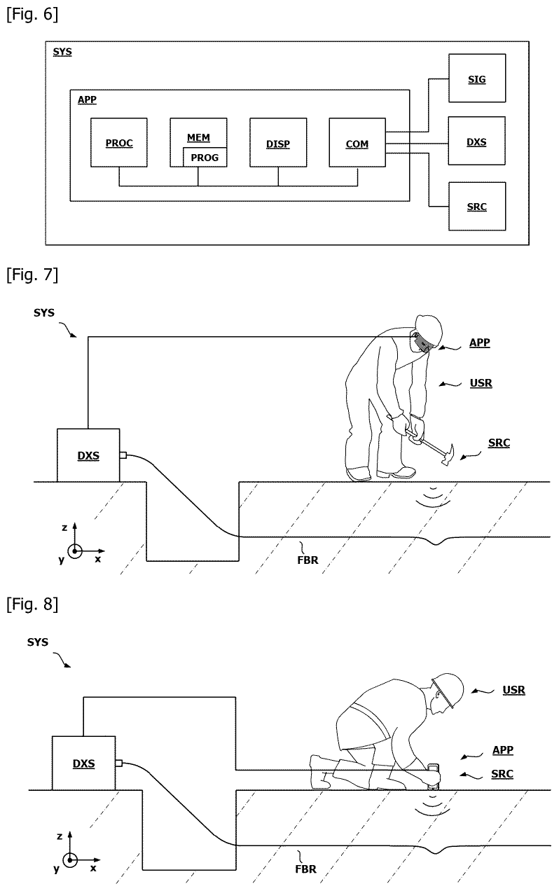

The operation of the locating device APP is described hereinafter with reference to FIGS. 2 to 5, and the hardware architecture is described with reference to FIG. 6.

FIG. 2 illustrates the steps of a method for locating an optical fiber according to an embodiment of the disclosure. The figure illustrates the operation of the locating device APP previously introduced.

According to the embodiment illustrated in FIG. 2, the proposed method comprises all or part of the steps S100 to S300 described hereinafter and implemented by the device APP.

During step S100, the device APP obtains one or a plurality of theoretical positions POS_SIG of the optical fiber FBR (i.e. expected or entered positions). More particularly, the device receives the location information from the geographic information system SIG.

During step S200, the device APP determines at least one position of the optical fiber POS_FBR in a given search zone.

The device APP can perform a plurality of iterations of step S200 for different search zones. The device thereby determines a plurality of positions of the fiber POS_FBR. We are discussing this point in detail with reference to FIG. 4.

To determine a position of the fiber POS_FBR in a given search zone, and according to the embodiment shown in FIG. 2, step S200 comprises all or part of steps S210 to S250 described hereinafter.

In step S210, the device APP obtains a position POS_SRC of the source SRC of stimuli. The position POS_SRC can be defined with respect to the ground surface, or in an absolute manner with respect to the terrestrial reference frame (e.g. geographical coordinates provided by a positioning device of a terminal).

The position POS_SRC of the source can be obtained in different ways. Same can be supplied to the device APP by the source SRC as such, as illustrated by FIG. 1. In a variant, the position POS_SRC may correspond to the position of the user terminal APP implementing the location of the fiber FBR. The position POS_SRC can also be determined by the device APP, then indicated to a user (e.g. technician) who will generate vibrations at the indicated position. The different embodiments are described with reference to FIGS. 7 to 9.

During step S220, the device APP controls the source SRC and/or the detection device DXS. Same sends to the source SRC, a command CMD_SRC comprising an instruction to generate stimuli, and/or sends to the detection device DXS, a command CMD_DXS comprising an instruction to measure a detection level of the source DET_LVL.

Alternatively, the source SRC and the detection device DXS could operate autonomously or be controlled by a user.

During step S230, the device APP obtains a detection level DET_LVL from the source SRC. The detection level is provided by the detection device DXS and is associated with the position of the source POS_SRC.

The device APP can indicate to a user, the detection level DET_LVL obtained for the position of the source POS_SRC (e.g. via an application on a terminal).

During step S240, the device APP determines whether a stop criterion STP_CRT is satisfied. If such is the case, the method continues at step S250. Otherwise, the method repeats the steps S210-S230 so as to obtain an additional detection level DET_LVL for a different position of the source POS_SRC.

The stop criterion STP_CRT corresponds, according to one embodiment, to the fact that a maximum detection level of the source DET_LVL has been detected by the device APP and/or signaled by a user. The device APP can also indicate to the user that a maximum detection level DET_LVL has been detected (e.g. via an application on a terminal).

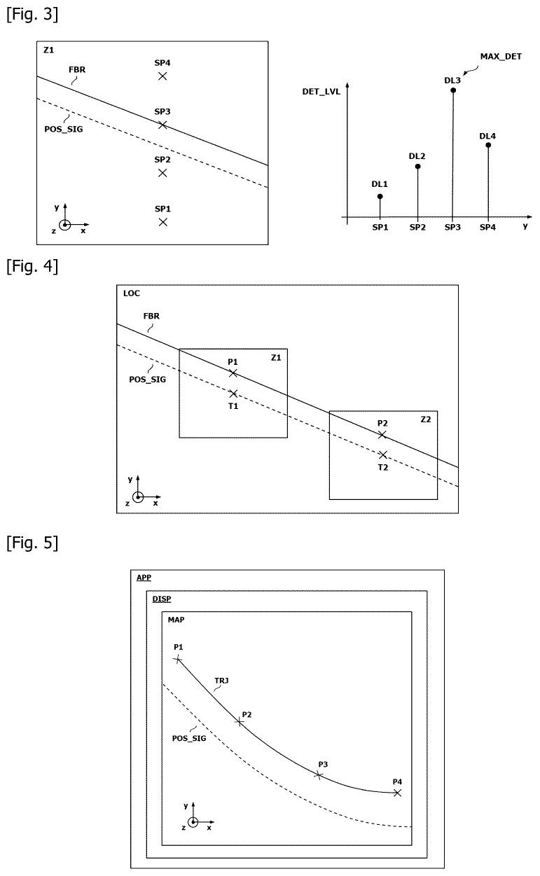

If a maximum has not been detected or signaled, the device APP reiterates steps S210-S230 to obtain a detection level DET_LVL associated with another position of the source POS_SRC. The source SRC of stimuli can thereby be moved from one to another to reach a maximum detection level of the source SRC. We present an example of searching for the maximum detection level with reference to FIG. 3.

In the context of the disclosure, it could be envisaged to use other stop criteria. For example, a stop criterion may correspond to obtaining a sufficient number of measurements, i.e. a number of detection levels associated with different positions of the source above a threshold.

During step S250, the device APP estimates a position of the fiber POS_FBR based on the detection levels DET_LVL obtained and the associated source positions POS_SRC.

The estimated position POS_FBR is a planar position. Same characterizes the location of a point on the fiber FBR in a plane substantially parallel to the ground (the plane x-y in the figures). Same can be defined relative to the surface of the ground, or in an absolute way relative to the terrestrial reference frame (e.g. geographical coordinates).

More particularly, the estimated position of the fiber POS_FBR corresponds to (is associated with) the position of the source SRC for which the detection level DET_LVL obtained is maximum, among the different positions of the source POS_SRC in the search zone considered. In other words, the device APP associates a position of a point of the sought-after fiber FBR with the position of the source POS_SRC for which a maximum detection level is detected and/or signaled.

In the context of the disclosure, other embodiments could also be envisaged. The position of the optical fiber POS_FBR could be estimated by using an interpolation of the detection levels, then by selecting the position for which the interpolated detection level is maximum. The device APP can also use the other information supplied by the detection device DXS, such as the distance DET_DIST, to estimate the position of the fiber FBR.

Furthermore, we have described herein the proposed solution by considering a plurality of detection levels DET_LVL associated with different positions of the source POS_SRC. However, it is possible to obtain an estimate of the position of the fiber POS_FBR from a single DET_LVL detection level and the position of the associated position of the source POS_SRC, e.g. by using reference models or reference data, or other information provided by the detection device DXS.

According to one embodiment, the device APP obtains in step S250, a depth of the fiber DPT with respect to the surface of the ground. The optical fiber FBR is thereby located in three dimensions. The depth DPT is determined either by the detection device DXS or by the device APP as such.

More precisely, the depth DPT is determined based on the maximum detection level obtained, i.e. the detection level obtained at the position of the source POS_SRC associated with the estimated position of the fiber POS_FBR. The depth of the optical fiber DPT can be determined from a detection level DET_LVL, using reference models (e.g. a model of acoustic wave propagation in the ground), or reference data (e.g. detection levels obtained for different depths of the fiber in a ground).

During step S300, the device APP supplies a map representative of at least one determined position of the fiber POS_FBR. The map MAP corresponds to a graphical representation on which the optical fiber FBR is located. We present the map MAP in more detail, with reference to FIG. 5.

More particularly, the device APP gives the map MAP to a user via a display device DISP. In a variant, the map MAP and/or the determined positions POS_FBR could be communicated by the device APP to another device in order to be stored or displayed.

The proposed method thereby allows to accurately locate a buried optical fiber, in a non-invasive way. It should be noted that the order wherein the steps described above follow one another is only an example of embodiment, other variants being possible.

The proposed method comprises all or part of the steps implemented by the locating device APP. Furthermore, the proposed method may comprise the steps implemented by the detection device DXS and/or the source SRC.

FIG. 3 illustrates an example of a search zone for an optical fiber and of detection levels used by a locating system according to one embodiment of the disclosure. The figure is presented to show an example of implementation of step S200, during which the device APP determines a position of the fiber POS_FBR in a search zone.

The figure illustrates a top view of a search zone Z1. The location information POS_SIG entered during the installation of the fiber FBR is indicated as dotted lines, while the actual location of the fiber FBR is represented as solid lines.

As mentioned hereinabove, and according to one embodiment, the device APP obtains a plurality of detection levels DET_LVL associated with different positions of the source POS_SRC (e.g. by performing a plurality of iterations of steps S210-230). Same then uses the detection levels DET_LVL to locate the optical fiber FBR.

Let us look at the example shown in FIG. 3. A user of the device APP moves the source SRC of stimuli (along the axis y) and seeks to maximize the detection level DET_LVL provided by the detection device DXS. The device APP thereby obtains the detection levels DL1-DL4 correspondingly associated with the positions of the source SP1-SP4. The device APP then associates the position of the source SP3, for which the maximum detection level MAX_DET has been obtained, with a position of the fiber POS_FBR.

We have described herein a particular example of searching for the maximum detection level. Of course, other search strategies could be considered. For example, the source SRC of stimuli could be moved using a cross or spiral search method, or else by crisscrossing the search zone Z1.

It should also be noted that the device APP can guide the user in the search for the maximum detection level by indicating the detection level DET_LVL provided by the device DXS. Same can also indicate to the user that a maximum level MAX_DET has been detected.

FIG. 4 illustrates an example of search zones for an optical fiber, used by a locating system according to one embodiment of the disclosure.

The figure is described in order to exemplify the implementation of a plurality of iterations of step S200, during which the device APP determines a plurality of positions of the fiber POS_FBR in different search zones. The description given hereinafter is merely an example of an embodiment of the disclosure, since other search strategies can be used to locate an optical fiber FBR.

The figure represents a geographical zone LOC (e.g. a room of a building) seen from above. The optical fiber FBR is buried in the ground of the zone LOC, and the locating system SYS is used to locate the latter.

The device APP selects a first search zone Z1 around a theoretical position T1 of the optical fiber FBR. The theoretical position T1 is obtained from the location information POS_SIG entered during the installation. The device APP implements the step S200 described hereinabove for the first search zone Z1, and thereby determines a first position P1 of the optical fiber. The device APP then selects a second search zone Z2 centered around another theoretical position T2 of the fiber. Same then determines a second position P2 of the optical fiber in the search zone Z2 by implementing step S200.

By reiterating in this way step S200 for different search zones within a geographical zone LOC, the device APP allows to locate the optical fiber FBR and to accurately determine the path thereof through the ground. Same then provides the user with a map representative of the determined positions of the fiber POS_FBR, which is described in detail with reference to the following figure.

FIG. 5 illustrates an example of a map provided by a device for locating an optical fiber according to an embodiment of the disclosure. The figure illustrates an example of a map MAP provided during step S300 by the locating device APP.

As mentioned hereinabove, the device APP can display the map MAP representative of the determined positions of the fiber FBR using a display device DISP (e.g. the screen of a user terminal, or augmented reality glasses).

According to one embodiment, the map MAP provided by the device APP indicates the different determined positions of the fiber FBR, i.e. the location points of the optical fiber. FIG. 5 illustrates location points P1-P4 of the optical fiber FBR. It could also be envisaged for the map MAP to indicate one or a plurality of theoretical positions POS_SIG of the optical fiber FBR.

According to one embodiment, the map MAP provided by the device APP comprises a layout of the fiber TRJ obtained from the determined positions P1-P4. As a result, a user can see the path of the optical fiber FBR through the ground. The map MAP can indicate either the location points of the fiber P1-P4 or the layout of the fiber TRJ, or even both at the same time. The latter case is illustrated in FIG. 5.

According to such embodiment, the device APP generates the layout of the fiber TRJ from the determined positions POS_FBR. Same thereby implements a step of interpolation or regression of the determined positions of the optical fiber POS_FBR.

The device APP can use any interpolation or regression technique to generate the layout TRJ. We can cite e.g. linear or polynomial interpolation techniques, or spline interpolations. Also, the device APP could use a linear or non-linear regression, or even a machine learning algorithm (e.g. an artificial neural network) to generate the layout TRJ.

It should be noted that in the case of interpolation, the layout of the fiber TRJ runs through the determined positions POS_FBR, as illustrated in FIG. 5. In the case of a regression, the layout TRJ of the fiber may not run through the determined positions POS_FBR and may only approach thereto.

In addition, the device APP can use a minimum radius of curvature of the optical fiber to generate the layout TRJ of the fiber. Depending on the type of optical fiber FBR, the fiber is installed with a certain minimum radius of curvature. If the optical fiber FBR has a bend the radius of curvature of which is less than said minimum, the operation of the optical fiber is not ensured, and the fiber could be damaged. It is thus proposed herein to use the minimum radius of curvature to generate the layout TRJ of the fiber, i.e. the generated layout TRJ follows the requirement of curvature of the fiber FBR.

We have described hereinabove the operation of the locating device APP. We now describe the hardware architecture with reference to the following figure.

FIG. 6 illustrates the architecture of a system for locating an optical fiber according to one embodiment of the disclosure.

The locating system SYS comprises all or part of the following elements: the locating device APP, the system SIG, the detection device DXS, and the source SRC.

The locating device APP comprises, according to the embodiment shown in FIG. 6, at least one processor PROC, and at least one memory MEM.

More particularly, the device APP has, according to one embodiment, the hardware architecture of a computer. The memory MEM forms a data storage medium according to the disclosure, i.e. readable by the processor PROC and on which is recorded a computer program PROG according to the disclosure. The program PROG includes instructions for carrying out steps of a locating method according to the disclosure, when the program PROG is executed by the processor PROC. The program PROG defines in particular the functional modules of the device APP, which control the hardware elements of the latter.

The device APP may also comprise a display device DISP. The display device DISP can e.g. be used to give the map MAP to a user. Same could also be used to signal to a user, the detection levels DET_LVL provided by the detection device DXS.

As shown in FIG. 6, the device APP comprises a communication device COM configured to communicate with the detection device DXS, and/or the source SRC, and/or the system SIG. No limitation is attached to the nature of the communication interfaces between the devices, which may be wired or non-wired, and may implement any protocol known to a person skilled in the art.

In general, for each step (or operation) of a method of locating an optical fiber according to the disclosure, the device APP may comprise a corresponding element configured to perform said step.

More particularly, according to one embodiment, the locating device APP comprises at least one of the following elements:
a device for obtaining a source detection level (e.g. a receiver) configured to obtain at least one detection level DET_LVL of the source SRC for a position of the source POS_SRC and provided by the detection device DXS connected to the fiber FBR; and
an optical fiber position estimator configured to estimate at least one position of the optical fiber POS_FBR based on the at least one obtained detection level DET_LVL.

We have presented hereinabove a particular embodiment of the proposed locating system, illustrated in particular by FIG. 1. Other embodiments of the system SYS are presented with reference to the following figures.

FIG. 7, FIG. 8 and FIG. 9 illustrate a system for locating an optical fiber according to embodiments of the disclosure.

The figures illustrate, as an example, a plurality of embodiments of the locating system SYS. The system SYS can further comprise one or a plurality of the following features, taken individually or according to any technically possible combination.

FIG. 7 illustrates an embodiment wherein the device APP is implemented by augmented reality glasses worn by a user USR (e.g. a technician). The source SRC of stimuli is produced herein by the user USR who hits the ground with a tool (e.g. a hammer). According to such embodiment, the device APP locates the buried optical fiber FBR by proceeding as follows.

The device APP determines a position POS_SRC of the source SRC of vibration (step S210). Same indicates said position to the user USR, who sees the position appear in his/her field of view. The user USR then strikes the ground with his/her tool at the indicated position. The device APP communicates with the detection device DXS to obtain the detection level of the source DET_LVL associated with the position POS_SRC (step S230).

The device APP reiterates the steps to obtain a plurality of detection levels DET_LVL associated with different positions of the source POS_SRC. Same then uses the detection levels obtained to determine a position of the optical fiber POS_FBR (step S250).

The use of augmented reality glasses is particularly advantageous in that same allows the USR user to be interactively guided to locate the optical fiber FBR.

FIG. 8 illustrates an embodiment wherein the locating device APP is implemented by the terminal of a user USR (e.g. a smartphone, or a tablet). The device APP also produces the source SRC of stimuli, e.g. by using the loudspeaker of the terminal. An example of the operation of the locating device APP according to such embodiment is presented hereinafter.

The user USR places the device APP on (or in the vicinity of) the floor surface. The device APP obtains the position POS_SRC of the source SRC of stimuli by locating the device APP (step S210). To obtain the position POS_SRC, the device APP uses e.g. a GPS receiver or any other means of positioning. Then, the device APP activates the stimuli source SRC (step S220). Same receives from the detection device DXS a t level DET_LVL associated with the position of the source POS_SRC (step S230). The device APP can thereby obtain a plurality of detection levels DET_LVL for different positions of the source POS_SRC, and deduce therefrom a position of the fiber POS_FBR (step S250).

Such embodiment advantageously enables the user USR to locate the optical fiber FBR only from his/her terminal APP and from the detection device DXS.

FIG. 9 illustrates an embodiment wherein the locating device APP is implemented by the terminal of a user USR. According to such embodiment, the device APP controls a source SRC of stimuli, configured to generate acoustic and/or mechanical vibrations, and/or heat. The figure illustrates a source SRC of stimuli implemented by a terrestrial device (e.g. a robot), but an aerial device (e.g. a drone) could also be used.

The device APP can proceed as follows in order to locate the optical fiber FBR. First, the device APP obtains the position of the source POS_SRC (step S210). For example, the source device SRC moves autonomously and communicates the position POS_SRC thereof to the device APP. In a variant, the device APP controls the source device SRC so that same reaches a given position POS_SRC.

The device APP then sends to the source SRC device, an instruction for generating stimuli (step S220). The device APP communicates with the detection device DXS to obtain a detection level of the source DET_LVL associated with the position POS_SRC (step S230). The device APP uses one or a plurality of detection levels DET_LVL thereby obtained, in order to determine the position of the fiber POS_FBR (step S250).

The embodiment allows to automate the location of the optical fiber, and to limit the interventions needed on the part of the user (e.g. a technician). Since the different devices of the locating device are controlled automatically, the embodiment enables the optical fiber to be located in a particularly precise way.

Additional variants: A person skilled in the art would understand that the embodiments and variants described hereinabove are only non-limiting examples of implementation of the disclosure. More particularly, a person skilled in the art may envisage any adaptation or combination of the embodiments and variants described hereinabove in order to meet a very particular need.

It should also be noted that the order in which the steps of a method according to the disclosure are sequenced, in particular with reference to the enclosed drawings, form only one example of embodiment which is not limiting in any way, variants being possible. More particularly, a method according to the disclosure may comprise one or a plurality of iterations of the steps described hereinabove, in particular with reference to the enclosed drawings. Moreover, the reference signs do not limit the scope of the protection, the sole function thereof being to facilitate the understanding of the claims.

1. A method of locating an optical fiber buried in a volume, the method being performed by a locating device and comprising at least:
determining a position of the optical fiber based on at least one detection level of a source of radiation for at least one position of the source provided by a detection device connected to the optical fiber
and wherein determining a position of the optical fiber comprises:
obtaining a depth of the optical fiber with respect to a surface of the volume, the depth being determined based on said detection level.

2. The method according to claim 1, wherein said estimated position of the optical fiber corresponds to the position of the source for which the detection level obtained is maximum among a plurality of positions of the source situated in a search zone.

3. The method according to claim 1, comprising a plurality of determining a position of the optical fiber correspondingly performed for different search zones, wherein said position of the optical fiber is determined based on at least one detection level obtained for at least one position of the source comprised in said corresponding search zone.

4. The method according to claim 1, comprising:
providing a map representative of at least one determined position of the optical fiber.

5. The method according to claim 4, wherein providing the map comprises at least a step among the following:
interpolating determined positions of the optical fiber; and
regressing determined positions of the optical fiber.

6. The method according to claim 1, wherein a given detection level is determined using at least one neural network.

7. The method according to claim 1, wherein said at least one determining a position of the optical fiber comprises:
sending to the source, an instruction to generate vibrations and/or heat;
and/or sending to the detection device, an instruction to measure a detection level.

8. A locating device for locating an optical fiber buried in a volume, the device comprising:
at least one processor; and
at least one non-transitory computer readable medium comprising instructions stored thereon which when executed by the at least one processor configure the locating device to determine at least one position of the optical fiber based on at least one detection level of a source of radiation for at least one position of the source provided by a detection device connected to the optical fiber,
and wherein determining a position of the optical fiber comprises: obtaining a depth of the optical fiber with respect to a surface of the volume, the depth being determined based on said detection level.

9. The locating device according to claim 8, wherein the locating device is one among: a user terminal, and an augmented reality device.

10. The device according to claim 9, wherein the locating device is the augmented reality device and wherein the augmented reality device comprises an indicator configured to indicate to a user, a position of the source.

11. The device according to claim 8, wherein the source of radiation is a source of vibration and/or of heat.

12. A system for locating an optical fiber buried in a volume, the system comprising:
a detection device to be connected to the optical fiber and configured to provide at least one detection level of a source of radiation; and
an optical fiber locator configured to determine at least one position of the optical fiber based on at least one detection level,
and wherein determining a position of the optical fiber comprises: obtaining a depth of the optical fiber with respect to a surface of the volume, the depth being determined based on said detection level.

13. The system according to claim 12, comprising the source of radiation, the source being controlled by a locating device comprising the optical fiber locator.

14. A non-transitory computer-readable medium having stored thereon instructions which, when executed by a processor, cause the processor to implement the steps of the method according to claim 1.
